(19) United States
(12) Patent Application Publication
(10) Pub. No.: US 2011/0169427 A1
(43) Pub. Date: Jul. 14, 2011

(54) CIRCUIT ARRANGEMENT AND METHOD FOR OPERATION OF A DISCHARGE LAMP

(75) Inventors: Alois Braun, Neuburg (DE); Walter Limmer, Muenchen (DE); Maximilian Schmidl, Pullach (DE)

(73) Assignee: OSRAM GESELLSCHAFT MIT BESCHRAENKTER HAFTUNG, Muenchen (DE)

(21) Appl. No.: 13/119,204

(22) PCT Filed: Sep. 17, 2008
(86) PCT No.: PCT/EP2008/062358

§ 371 Date: Mar. 16, 2011

(51) Int. Cl. H05B 41/36

(52) U.S. Cl. 315/307

(57) ABSTRACT

In various embodiments, a circuit arrangement may include a voltage-measuring device embodied to measure an output voltage, wherein the voltage-measuring device is embodied to provide at its output a signal which is correlated with the measured output voltage, wherein the voltage-measuring device is coupled to a control device for the purpose of transmitting said signal to the control device, and wherein the control device is embodied to vary an off-time as a function of the measured output voltage.

### TECHNICAL FIELD

The present invention relates to a circuit arrangement for operating a discharge lamp, the circuit arrangement including an input having a first input terminal and a second input terminal for connecting a supply voltage, a first electronic switch which has a control electrode, a working electrode and a reference electrode, the working electrode being coupled to the first input terminal, a first diode whose anode is coupled to the second input terminal and whose cathode is coupled to the reference electrode of the first electronic switch while forming a first junction point, a control device which is coupled to the control electrode of the first electronic switch for the purpose of driving the latter, an output having a first and a second output terminal for providing an output voltage to the discharge lamp, an inductor arranged in series with one of the output terminals, a lamp inductor which is coupled between the first junction point and the first output terminal, and a first capacitor which is coupled between the first output terminal and the anode of the first diode, wherein the control device is embodied to switch the first electronic switch continuously to conducting for an on-time and to non-conducting for an off-time. It relates in addition to a corresponding method for operating a discharge lamp.

### PRIOR ART

A circuit arrangement of this kind is known from the prior art. It is constituted essentially in the form of a buck converter with downstream-connected ignition or firing device for the discharge lamp, wherein the cited inductor represents the ignition inductor. In practice it has now been recognized that discharge lamps that are operated on such a circuit arrangement sometimes go out. As a result of the introduction of additional ohmic resistors into the output circuit, i.e. in series with the discharge lamp, it was possible to a large extent to prevent the extinction. However, this solution is undesirable with regard to the resulting power dissipation.

### DESCRIPTION OF THE INVENTION

The object of the present invention therefore consists in developing a circuit arrangement and method of the kind cited in the introduction in such a way that an extinction of the discharge lamp is reliably prevented with little power dissipation.

This object is achieved by means of a circuit arrangement having the features recited in claim 1 and by means of a method having the features recited in claim 14.

The present invention is based on the knowledge that oscillations can occur in the output circuit as a function of the ignition inductor and the first capacitor. At low lamp impedances they are attenuated only to a limited degree and can interfere with the operation of the lamp because the lamp current oscillates. In the conventional further wiring of a generic circuit arrangement known from the prior art, a measurement of the output current is provided, the output current being regulated peak-to-peak at a fixed frequency by corresponding activation of the first electronic switch. If an oscillation now occurs in the output circuit, this can result in make cycles being omitted completely and the effective control frequency approaching the resonance frequency which is essentially determined by the ignition inductor and the first capacitor. The control circuit therefore becomes “involved in the oscillation”. In this case the current can even oscillate into the negative range and thereby cause extinction of the lamp.

The approach known from the prior art of inserting ohmic resistors into the output circuit inadvertently served to attenuate the oscillation, but led to undesirably high power dissipation.

On the basis of these findings the present invention eliminates the above-cited problem in that the circuit arrangement is not operated almost at a fixed frequency in continuous mode, but instead the off-time of the first electronic switch is varied. The distance from the cited resonance frequency is determined by measuring the output voltage and a sufficient distance from said resonance frequency is established by varying the off-time. By this means an “involvement” of the control circuit in the oscillation is reliably avoided. As a result thereof an extinction of the discharge lamp can be reliably avoided even without use of additional ohmic resistors for attenuating the output circuit.

The control device may be embodied to vary the off-time in proportion, in particular directly or indirectly in proportion, to the output voltage. The control device may be embodied in particular to shorten the off-time if there is an increase in the output voltage and vice versa. If Tₒₙ represents the on-time, T_{off} the off-time, L_{Z} the inductor arranged in series with one of the output terminals, and C₁ the capacitance of the first capacitor, then the control device is embodied in particular to vary the off-time in such a way that the following applies:

$$\frac{1}{{T}_{on} + {T}_{off}} \neq \frac{1}{2 π \sqrt{{L}_{{C}_{2}}}}$$

By varying the off-time the control device particularly preferably avoids a range of 20 percent below to 20 percent above the resonance frequency, with the result that the following applies:

$$\frac{1}{{T}_{on} + {T}_{off}} \neq 0.8 to 1.2 * \frac{1}{2 π \sqrt{{L}_{{C}_{2}}}}$$

In order to ensure that harmonics of the resonance frequency are also avoided, the following also applies:

$$\frac{1}{n * ( {T}_{on} + {T}_{off} )} \neq \frac{1}{2 π \sqrt{{L}_{Z} {C}_{1}}} ;$$

where n=1, 2, 3, . . . .

In this connection it is in turn particularly preferred if a range of 20 percent below to 20 percent above the respective frequency is avoided, such that the following applies:

$$\frac{1}{n * ( {T}_{on} + {T}_{off} )} \neq 0.8 to 1.2 * \frac{1}{2 π \sqrt{{L}_{Z} {C}_{1}}} ;$$

where n=1, 2, 3, . . . .

In particular when the impedance of the discharge lamp that is to be connected at the output is not to be ignored, the detuning of the oscillating circuit consisting of the first capacitor and the inductor due to the impedance of the discharge lamp that is to be connected at the output should be taken into account in the respective above-cited formula. In this way particularly precise values can be determined for the frequencies that are to be avoided and taken into account in the control function handled by means of the control device.

A circuit arrangement according to the invention preferably includes in addition a current-measuring resistor which is coupled between the anode of the first diode and the second input terminal for the purpose of measuring the current through the first electronic switch in the conducting state of the latter, the control device being coupled to the current-measuring resistor and being embodied to vary the on-time for the purpose of regulating the current to a predefinable value. In this case the on-time is regulated in particular so that the average current remains constant in spite of the different off-times.

The aforementioned embodiment variants of a circuit arrangement according to the invention relate in particular to implementations having a single electronic switch. However, the concept underlying the present invention can also be applied in particular to a full-bridge topology. In this respect a preferred development of a circuit arrangement according to the invention also includes a second, third and fourth electronic switch, the first, second, third and fourth electronic switch representing a full-bridge, the first junction point representing a first bridge center point, the circuit arrangement additionally including a second diode coupled in parallel with the first electronic switch, the second electronic switch being coupled in parallel with the first diode, the third and fourth electronic switch being coupled to each other while forming a second junction point representing a second bridge center point, the second bridge center point representing the second output terminal, the control device being embodied according to the invention to drive the first, second, third and fourth electronic switch. In this case the control device is preferably embodied to switch the third electronic switch to conducting and the fourth electronic switch and the first electronic switch to non-conducting in a first phase, and to switch the fourth electronic switch to conducting and the third electronic switch and the second electronic switch to non-conducting in a second phase, the first and the second phase continuously alternating at a first predefinable frequency lying in particular in the low-frequency range, the control device furthermore being embodied to switch the second electronic switch to conducting and non-conducting in alternation in the first phase and the first electronic switch to conducting and non-conducting in alternation in the second phase at a second predefinable frequency lying in particular in the high-frequency range, and in so doing to vary the off-time as a function of the measured output voltage.

A freewheeling diode is preferably connected in parallel with the third and fourth electronic switch in each case.

In addition the circuit arrangement preferably includes a second capacitor which is coupled between the first input terminal and the first output terminal. In this case the total capacitance from first and second capacitor should be applied in the above equations instead of the capacitance of the first capacitor.

Further preferred embodiment variants will become apparent from the dependent claims.

The preferred embodiment variants presented with reference to a circuit arrangement according to the invention and their advantages pertain analogously, insofar as they are applicable, to the method according to the invention.

### BRIEF DESCRIPTION OF THE DRAWING(S)

Exemplary embodiments of the invention will now be described in more detail below with reference to the attached drawings, in which:

FIG. 1 is a schematic diagram illustrating a first exemplary embodiment of a circuit arrangement according to the invention having a single electronic switch;

FIG. 2 is a schematic diagram illustrating a second exemplary embodiment of a circuit arrangement according to the invention having a full-bridge topology;

FIG. 3 shows the variation with time of various currents in a peak-to-peak regulation according to the prior art; and

FIG. 4 shows the variation with time of corresponding variables in the case of resonance according to the prior art.

### PREFERRED EMBODIMENT OF THE INVENTION

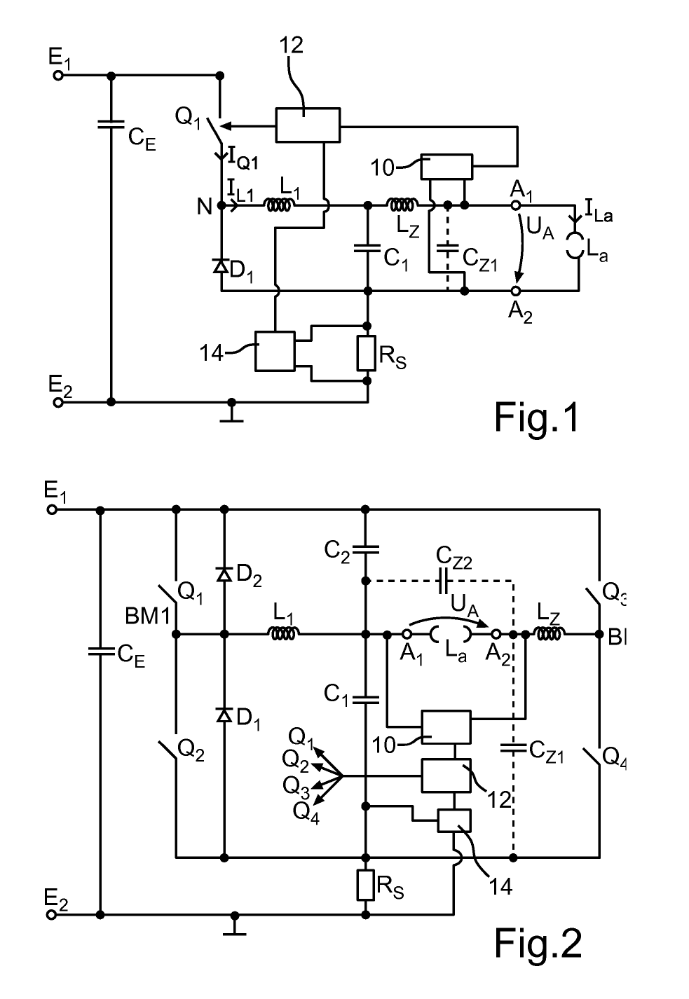

FIG. 1 is a schematic diagram illustrating a first exemplary embodiment of a circuit arrangement according to the invention. This includes an input having a first input terminal E₁ and a second input terminal E₂ to which a supply voltage can be connected. Arranged between the inputs is an optional capacitor C_{E} which serves to stabilize the input voltage. The circuit arrangement includes a first electronic switch Q₁ having a control electrode, a working electrode and a reference electrode. The working electrode is coupled to the first input terminal E₁. Also present is a diode D₁ whose cathode is coupled to the reference electrode of the electronic switch Q₁ while forming a junction point N. The circuit arrangement also includes an output having a first output terminal A₁ and a second output terminal A₂ at which an output voltage U_{A} is provided to a discharge lamp La. Arranged between the junction point N and the first output terminal A₁ is the series connection consisting of a lamp inductor L₁ and an ignition inductor L_{Z}. The junction point between the lamp inductor L₁ and the ignition inductor L_{Z} is coupled to the second output terminal A₂ via a capacitor C₁. The anode of the diode D₁ is likewise coupled to the output terminal A₂.

A voltage-measuring device 10 is provided for the purpose of measuring the output voltage U_{A}. A variable that is correlated with the measured output voltage U_{A} is coupled to a control device 12 which is coupled to the control electrode of the electronic switch Q₁ in order to drive the latter. In addition the control device 12 is coupled to a current-measuring device 14 which measures the voltage via a current-measuring resistor R_{S} which is coupled between the anode of the diode D₁ and the second input terminal E₂ and provides said voltage to the control device 12. An ignition capacitor C_{Z1} is indicated in the drawing by a dashed line. According to the invention the control device 12 is embodied to vary the off-time of the switch Q₁ as a function of the measured output voltage U_{A}. The off-time is varied in particular in such a way that the frequency at which the switch Q₁ is driven is different from a resonance frequency and its multiples, which are essentially defined by the ignition inductor L_{Z} and the first capacitor C₁. The current flowing through the lamp inductor L₁ is designated by I_{L1}, the current flowing through the lamp La by I_{La}, and the current flowing through the switch Q₁ by I_{Q1}.

FIG. 2 is a schematic diagram illustrating a second exemplary embodiment of a circuit arrangement according to the invention, wherein the circuit arrangement now has a full-bridge topology. Reference signs introduced in connection with FIG. 1 continue to apply to like and like-acting components of FIG. 2 and therefore do not need to be reintroduced here.

This circuit arrangement additionally includes a second switch Q₂, a third switch Q₃ and a fourth switch Q₄. A second diode D₂ is connected in parallel with the switch Q₁. A second capacitor C₂ is coupled between the first input terminal E₁ and the first output terminal A₁. A first bridge center point BM1 is formed between the first switch Q₁ and the second switch Q₂, and a second bridge center point BM2 is formed between the third switch Q₃ and the fourth switch Q₄. In the present arrangement the ignition inductor L_{Z} is disposed between the second output terminal A₂ and the second bridge center point BM2. Also indicated in the drawing is a further optional ignition capacitor C_{Z2} which can be provided as an alternative or in addition to the ignition capacitor C_{Z1}. This can be coupled in parallel with the two output terminals A₁, A₂.

The operation of the circuit arrangement according to FIG. 2 is realized by corresponding activation of the switches Q₁ to Q₄ by the control device 12. To that end the control device 12 drives the switch Q₄ as conducting and the switches Q₃ and Q₂ as non-conducting in a first phase. In a second phase the switch Q₃ is switched to conducting, and the switches Q₄ and Q₁ are switched to non-conducting. The first and second phase alternate continuously at a first predefinable frequency lying in particular in the low-frequency range. In the first phase the switch Q₁ and in the second phase the switch Q₂ are switched to conducting and non-conducting in alternation at a second predefinable frequency lying in particular in the high-frequency range. In this case the off-time is varied as a function of the measured output voltage U_{A} in such a way that the control frequency is different from the resonance frequency, which is essentially defined by the capacitors C₁, C₂ and the ignition inductor L_{Z}, and its multiples.

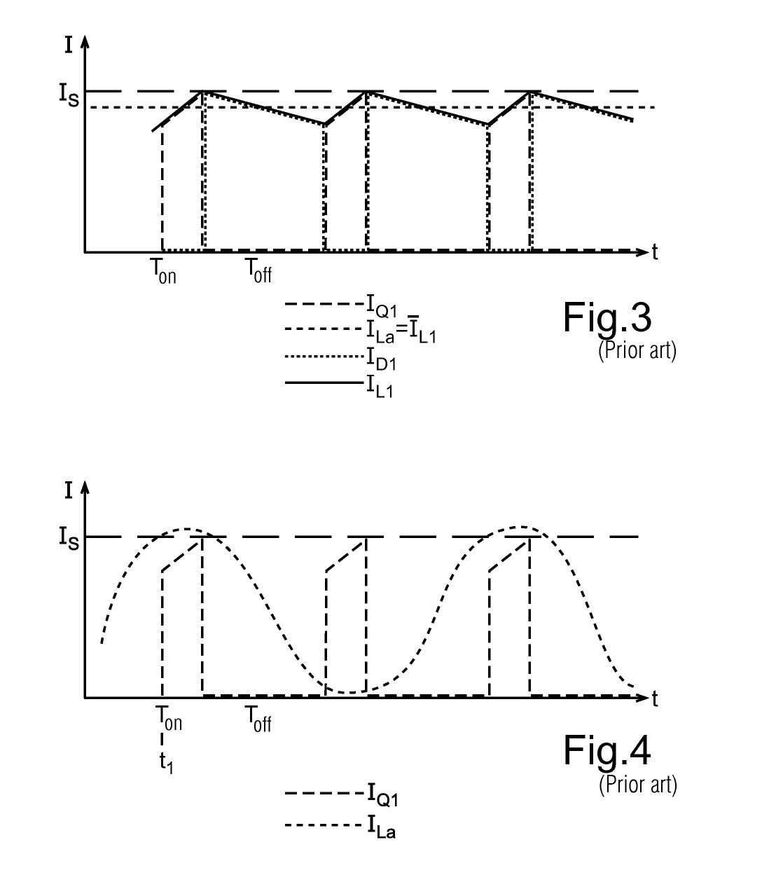

FIGS. 3 and 4 illustrate once again the considerations and findings on which this present invention is based. In respect of the basic topology shown in FIG. 2, FIG. 3 shows—albeit without inventive controller—the variation with time of various currents in the case of a peak-to-peak regulation of the current I_{Q1} through the switch Q₁. A cut-off current threshold I_{S} is represented in the diagram. As soon as the current through the switch reaches said current value I_{S}, the switch I_{Q1} is switched to the non-conducting state. The on-time equals Tₒₙ and leads to an increase in the current I_{L1} through the lamp inductor L₁. After the switch Q₁ is turned off, i.e. in the demagnetization phase of the lamp inductor L₁, the current through the lamp inductor I_{L1} decreases continuously, see T_{off}. Also included in the drawing is the current I_{D1} in the freewheeling phase, i.e. with switch Q₁ open. Finally, the current I_{La} provided to the discharge lamp La is entered, said current corresponding to the average current I_{L1transverse} through the lamp inductor L₁.

FIG. 4 shows the situation in the event of an oscillation occurring in the output circuit, i.e. an oscillation of the output current I_{La}. If an oscillation occurs in the output circuit, the current through the current-measuring resistor R_{S} receives an “offset” at the maximum of the oscillation, i.e. the turn-off time instant is reached earlier and initially the on-time Tₒₙ decreases. At the minimum of the oscillation the on-time Tₒₙ remains as before, i.e. more energy is coupled in at the minimum than at the maximum. In particular, energy is coupled in at the natural frequency of the oscillating circuit consisting of ignition inductor L_{Z} and capacitor C₁, C₂. Subsequently the circuit oscillates up, and the offset at the maximum increases until it is so high that at the turn-on time instant—see t₁ in FIG. 4—of the switch Q₁ the cut-off threshold is already reached. As a result the switch Q₁ no longer switches on. All of the energy is coupled in at the minimum and the circuit is excited at its resonance frequency. In other words: The control circuit “becomes involved in the oscillation”.

1. A circuit arrangement for operating a discharge lamp, the circuit arrangement comprising:
an input having a first input terminal and a second input terminal for connecting a supply voltage;
a first electronic switch which has a control electrode, a working electrode and a reference electrode, wherein the working electrode is coupled to the first input terminal;
a first diode whose anode is coupled to the second input terminal and whose cathode is coupled to the reference electrode of the first electronic switch while forming a first junction point;
a control device which is coupled to the control electrode of the first electronic switch for the purpose of driving the latter;
an output having a first output terminal and a second output terminal for providing an output voltage to the discharge lamp;
an inductor which is arranged in series with one of the output terminals;
a lamp inductor which is coupled between the first junction point and the first output terminal; and
a first capacitor which is coupled between the first output terminal and the anode of the first diode;
wherein the control device is embodied to switch the first electronic switch continuously to conducting for an on-time and to non-conducting for an off-time;
wherein the circuit arrangement further comprises a voltage-measuring device embodied to measure the output voltage, wherein the voltage-measuring device is embodied to provide at its output a signal which is correlated with the measured output voltage, wherein the voltage-measuring device is coupled to the control device for the purpose of transmitting said signal to the control device, and wherein the control device is embodied to vary the off-time as a function of the measured output voltage.

2. The circuit arrangement as claimed in claim 1,
wherein the control device is embodied to vary the off-time in proportion to the output voltage.

3. The circuit arrangement as claimed in claim 2,
wherein the control device is embodied to shorten the off-time if there is an increase in the output voltage and vice versa.

4. The circuit arrangement as claimed in claim 1,
wherein the control device is embodied to vary the off-time in such a way that the following applies:
$$\frac{1}{{T}_{on} + {T}_{off}} \neq \frac{1}{2 π \sqrt{{L}_{{C}_{2}}}}$$
where Tₒₙ represents the on-time, T_{off} the off-time, L the inductor arranged in series with one of the output terminals, and the capacitance of the first capacitor.

5. The circuit arrangement as claimed in claim 1,
wherein the following applies:
$$\frac{1}{{T}_{on} + {T}_{off}} \neq 0.8 to 1.2 * \frac{1}{2 π \sqrt{{L}_{{C}_{2}}}} ;$$

6. The circuit arrangement as claimed in claim 4,
wherein
$$\frac{1}{n * ( {T}_{on} + {T}_{off} )} \neq \frac{1}{2 π \sqrt{{L}_{Z} {C}_{1}}} ;$$
where n=1, 2, 3, . . . .

7. The circuit arrangement as claimed in claim 6, wherein
$$\frac{1}{n * ( {T}_{on} + {T}_{off} )} \neq 0.8 to 1.2 * \frac{1}{2 π \sqrt{{L}_{Z} {C}_{1}}} ;$$
where n=1, 2, 3, . . . .

8. The circuit arrangement as claimed in claim 4,
wherein the detuning of the oscillating circuit consisting of the first capacitor and the inductor as a result of the impedance of the discharge lamp that is to be connected at the output is taken into account in the respective formula.

9. The circuit arrangement as claimed in claim 1,
wherein it further comprises a current-measuring resistor which is coupled between the anode of the first diode and the second input terminal for the purpose of measuring the current through the first electronic switch in the conducting state of the latter, wherein the control device is coupled to the current-measuring resistor and is embodied to vary the on-time for the purpose of regulating the current to a predefinable value.

10. The circuit arrangement as claimed in claim 9,
wherein the circuit arrangement further comprises a second, third and fourth electronic switch, wherein the first, second, third and fourth electronic switch constitute a full-bridge, wherein the first junction point represents a first bridge center point,
wherein the circuit arrangement further comprises a second diode which is coupled in parallel with the first electronic switch, wherein the second electronic switch is coupled in parallel with the first diode, wherein the third and fourth electronic switch are coupled to each other while forming a second junction point which represents a second bridge center point, wherein the second bridge center point represents the second output terminal, wherein the control device is embodied to drive the first, second, third and fourth electronic switch.

11. The circuit arrangement as claimed in claim 10,
wherein the control device is embodied
to switch the third electronic switch to conducting and the fourth electronic switch and the first electronic switch to non-conducting in a first phase,
to switch the fourth electronic switch to conducting and the third electronic switch and the second electronic switch to non-conducting in a second phase,
wherein the first and second phase alternate continuously at a first predefinable frequency lying in particular in the low-frequency range,
wherein the control device is additionally embodied
to switch the second electronic switch in the first phase and the first electronic switch in the second phase alternately to conducting and to non-conducting at a second predefinable frequency lying in particular in the high-frequency range and in so doing to vary the off-time as a function of the measured output voltage.

12. The circuit arrangement as claimed in claim 10,
wherein a freewheeling diode is connected in parallel in each case with the third and fourth electronic switch.

13. The circuit arrangement as claimed in claim 1,
wherein the circuit arrangement further comprises a second capacitor which is coupled between the first input terminal and the first output terminal.

14. A method for operating a discharge lamp on a circuit arrangement comprising an input having a first input terminal and a second input terminal for connecting a supply voltage; a first electronic switch which has a control electrode, a working electrode and a reference electrode, wherein the working electrode is coupled to the first input terminal; a first diode whose anode is coupled to the second input terminal and whose cathode is coupled to the reference electrode of the first electronic switch while forming a first junction point; a control device which is coupled to the control electrode of the first electronic switch for the purpose of driving the latter; an output having a first output terminal and a second output terminal for providing an output voltage to the discharge lamp; an inductor which is arranged in series with one of the output terminals; a lamp inductor which is coupled between the first junction point and the first output terminal; and a first capacitor which is coupled between the first output terminal and the anode of the first diode; wherein the control device is embodied to switch the first electronic switch continuously to conducting for an on-time and to non-conducting for an off-time;
the method comprising:
a) measuring the output voltage;
b) coupling a signal which is correlated with the measured output voltage to the control device; and
c) by means of the control device: varying the off-time as a function of the measured output voltage.
